(19) United States
(12) Patent Application Publication
(10) Pub. No.: US 2004/0106704 A1
(43) Pub. Date: Jun. 3, 2004

(54) Admixture to improve rheological property of composition comprising a mixture of hydraulic cement and alumino-silicate mineral admixture

(76) Inventors: Christian Meyer, Demarest, NJ (US); Semyon Shimanovich, Brooklyn, NJ (US)

Correspondence Address: BAKER & BOTTS, 30 ROCKEFELLER PLAZA, NEW YORK, NY, 10112

(21) Appl. No.: 10/466,584

(22) PCT Filed: Sep. 18, 2001
(86) PCT No.: PCT/US01/29061

(51) Int. Cl. C08K 3/00

(52) U.S. Cl. 524/2

(57) ABSTRACT

Cement compositions including alumino-silicate and an imidized carboxylic polymer exhibit improved workability.

This invention relates to cement compositions having improved rheological properties and methods of making thereof. More particularly, this invention relates to cement compositions including alumino-silicates and an imidized polycarboxylic polymer which exhibits improved workability.

### BACKGROUND OF THE INVENTION

Concrete articles are typically prepared by pouring a cementitious composition into a mold and agitating and pressing it. Conventionally, combinations of alumino-silicate admixtures with hydraulic cements are used to prepare fire-resistant concrete articles, to increase the compressive strength of concrete, or to reduce the occurrence of alkali-silica reactions in cement compositions which include reactive silica aggregate materials. Unfortunately, the use of such alumino-silicate admixtures results in poor workability. The flow or slump properties of initially formed hydraulic cement mixtures must be sufficient to allow conveyance of the cement composition. The flowability must also last for a sufficient time to complete conveyance of the initially formed cement to a receptacle or mould structure.

Increased flowability of cement compositions including alumino-silicates can be achieved by adding more water to the composition. However, concrete articles prepared from such increased water content compositions will have poor compressive strength and may take a longer time to set.

In an attempt to reduce the water to cement ratio, additives referred to as superplasticizers such as lignosulfonate, sulphonated melamine formaldehyde condensates, salt of naphthalene and naphthalene sulphonate formaldehyde condensates have been added to the compositions. Unfortunately, such superplasticizers have not resulted in a hydraulic cement composition having the desired combination of properties when alumino-silicates are present in the hydraulic cement composition.

### SUMMARY OF THE INVENTION

Accordingly, it is an object of the invention to provide a hydraulic cement composition which includes alumino-silicates, which exhibits a high degree of slump over an extended period of time while not having any significant set retardation, and which can be used to prepare concrete articles having high compressive strength.

These and other objects of the invention are achieved by providing a hydraulic cement composition including an imidized carboxylic polymer, an alumino-silicate, water and cement wherein the weight ratio of water to cement is no greater than 0.6 to 1.

### DETAILED DESCRIPTION OF THE PREFERRED EMBODIMENTS

The hydraulic cement compositions of the present invention include cement, an alumino-silicate and an imidized polycarboxylic polymer. Concrete articles made in accordance with the invention include but are not limited to concrete paving stones, wall blocks, tiles and the like.

Any suitable hydraulic cement can be used with the hydraulic cement compositions of the invention. Suitable cements include but are not limited to Portland cement of one or more various types identified as ASTM Type I to V. The hydraulic cement is present in an amount of 20 to 91 weight % of the composition.

The hydraulic cement composition also includes an alumino-silicate. Suitable alumino-silicates include Class N Pozzolan, kaolins and variants thereof including metakaolin and high-reactivity metakaolin, for example, Metamax, a thermally activated alumino-silicate available from Engelhardt Corporation.

The hydraulic cement composition may also include aggregate material. Suitable aggregate material includes glass, sand, marble, granite and limestone. Preferred aggregate material is recycled glass as described in U.S. Pat. No. 5,810,921 which is incorporated by reference herein. The aggregate material is present in an amount up to 850 weight % of the hydraulic cement composition.

The cement composition may contain one ore more additives, such as color pigments, antifoaming agents and reinforcing fibers made of metallic, synthetic or mineral material. These additives are present in an amount of up to 20 weight % of the hydraulic cement composition.

The essential component of the inventive cement composition is an imidized polyacrylic polymer as described in U.S. Pat. No. 5,583,183 which is incorporated by reference herein having the general formula:

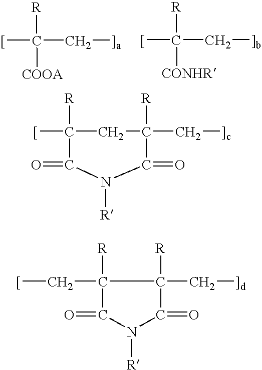

wherein each R independently represents hydrogen atom or a methyl (CH₃—) group; A represents a hydrogen atom, a C₁-C₁₀ alkyl group, or an alkali metal cation or a mixture thereof; R′ represents a hydrogen atom or an oxyalkylene group (BO)n—R″ where O is an oxygen atom, B is a C₂-C₁₀ alkylene group, n=1 to 200, and R″ is C₁-C₁₀ alkyl, or mixtures thereof; and a, b, c, and d represent molar percentages of the polymer's structure such that a has a value of about 50 to 70; the sum of c plus d is at least 2 to a value of (100-a) and is preferably from 3 to 10; and b is nor more than [100-(a+c+d)].

A preferred imidized polymer is represented by the above formula in which A is hydrogen or an alkali cation, and R′ is at 50 to 90 percent of the polymer and comprises polyoxyethylene or polyoxypropylene units or mixtures thereof. Further, it is preferred that a is a numerical sum of c and d value of from 60-70, and the sum of c and d is a numerical value of at least 3, preferably at least 5, up to the value of 100-a.

Preferred imidized polycarboxylic polymers include ADVA™ Flow and ADVA™ Caste available from W. R. Grace Company. The imidized polycarboxylic polymer is present in the hydraulic composition in an amount of up to 6 weight % of the hydraulic cement composition.

The water/cement weight ratio of the hydraulic composition is no greater than 0.60:1, preferably no greater than 0.40:1, more preferably no greater than 0.35:1, even more preferably no greater than 0.30:1, and most preferably no greater than 0.25:1.

The invention will be further understood, but is not limited to, the following examples.

### EXAMPLE 1

Cement compositions were prepared with 0.2 parts by weight kaolin type DB, 0.8 parts by weight Portland cement Type I, 1.724 parts by weight sand, and water cement ratios 0.35, 0.4, and 0.45. The flowability of these compositions admixed with either ADVA™ Flow, DARVAN-2 a lignosulfonate, Melment a sulphamate metamine formaldehyde condensate material, Pozzolith 400N a napthalene salt, and Tamol a napthanlene sulphonate formaldehyde condensate material was determined using ASTM C109/109M test procedure. The results are shown in Table 1.

TABLE 1
FLOWABILITY OF COMPOSITION OF CEMENT WITH KAOLIN AND SAND
(ASTM C109/C109M)

| | Water/ | | Type of admixtures | | | | |
|---|---|---|---|---|---|---|---|
| | Cement | Admixture | | | | Pozzolith | |
| Sample # | Ratio | content* | ADVA | DARVAN-2 | MELMENT | 400N | TAMOL |
| 1 | 0.55 | 0 | Reference - 78.1 | | | | |
| 2 | 0.45 | 0 | Reference - 48.4 | | | | |
| 3 | | 0.255 | 79 | N/A** | N/A | N/A | N/A |
| 4 | | 0.3 | 89.6 | N/A | N/A | N/A | N/A |
| 5 | | 0.375 | 95.3 | N/A | N/A | N/A | N/A |
| 6 | | 0.45 | 121.4 | N/A | N/A | 83.2 | N/A |
| 7 | | 0.5 | N/A | 86.3 | N/A | N/A | 83.4 |
| 8 | | 0.525 | 135.1 | N/A | N/A | N/A | N/A |
| 9 | | 0.6 | N/A | N/A | N/A | 96.1 | N/A |
| 10 | | 0.8 | N/A | N/A | N/A | 117.4 | N/A |
| 12 | | 1 | N/A | 106.5 | 97.9 | 136.7 | 110.4 |
| 13 | | 1.25 | N/A | 123.2 | 114.1 | 150 | 124.3 |
| 14 | | 1.5 | N/A | N/A | N/A | N/A | 136.1 |
| 15 | | 2 | N/A | N/A | 132.4 | N/A | 150 |
| 16 | 0.4 | 0 | Reference - 29.9 | | | | |
| 17 | | 0.255 | 56.5 | N/A | N/A | N/A | N/A |
| 18 | | 0.3 | 62.6 | N/A | N/A | N/A | N/A |
| 19 | | 0.375 | 79.9 | N/A | N/A | N/A | N/A |
| 20 | | 0.45 | 106.7 | N/A | N/A | N/A | N/A |
| 21 | | 0.5 | N/A | 60.7 | N/A | N/A | 51.8 |
| 22 | | 0.525 | 116.2 | N/A | N/A | N/A | N/A |
| 23 | | 0.6 | 129 | N/A | N/A | 82.4 | N/A |
| 24 | | 0.75 | N/A | 70.4 | N/A | N/A | N/A |
| 25 | | 0.8 | N/A | N/A | N/A | 98.1 | N/A |
| 26 | | 1 | N/A | 77.6 | 83.9 | 113.2 | 86 |
| 27 | | 1.25 | N/A | 96.2 | 87.9 | 124.1 | 103.9 |
| 28 | | 1.6 | N/A | N/A | N/A | 150 | 105 |
| 29 | | 2 | N/A | N/A | N/A | N/A | 116.3 |
| 30 | | 2.5 | N/A | N/A | N/A | N/A | 119.8 |
| 31 | | 3 | N/A | 150 | 107.8 | | N/A |
| 32 | 0.35 | 0 | Reference - 78 | | | | |
| 33 | | 0.45 | 81 | N/A | N/A | N/A | N/A |
| 34 | | 0.525 | 92 | N/A | N/A | N/A | N/A |
| 35 | | 0.75 | 136.5 | N/A | N/A | N/A | N/A |
| 36 | | 0.8 | N/A | N/A | N/A | 67.9 | N/A |
| 37 | | 0.9 | 150 | N/A | N/A | N/A | N/A |
| 38 | | 1 | N/A | 47.9 | 46.4 | 73.2 | N/A |
| 39 | | 1.25 | N/A | 72.6 | 47.5 | 88.6 | 68.8 |
| 40 | | 1.5 | N/A | N/A | N/A | N/A | 84.1 |
| 41 | | 1.6 | N/A | N/A | N/A | 109.7 | N/A |

*Solid content of waterbase admixture in weight percent of cement and kaolin.
**N/A = not available.

As can be seen from Table 1 the imidized polycarboxylic acid containing hydraulic cement compositions exhibited better flowability with lower dosage for all water/cement ratios.

For a composition with a water cement ratio of 0.45, a flowability value of 135% was obtained with only 0.525% of the imidized polycarboxylic polymer (ADVA). In contrast, to obtain comparable flow values, much higher amounts of the admixtures were required, i.e., 1.25% Darvan-2, 2% Melment, 1% Pozzolith 400N or 1.5% Tamol.

### EXAMPLE 2

Cement compositions were prepared with 0.09 parts by weight Metamax, 0.91 parts by weight Portland cement type I, 2.5 parts by weight fine sand aggregate having a particle size range according to ASTM C33-97 (Volume 04.02), and water cement ratios of 0.35, 0.40 and 0.45. The flowability of these compositions admixed with either ADVA™ Flow, DARVAN-2, Melment, Pozzolith 400N and Tamol was determined using ASTM C109/109M test procedures. The results are shown in Table 2.

TABLE 2
FLOWABILITY OF COMPOSITION OF CEMENT WITH
METAMAX AND SAND (ASTM C109/C109M)

| | Water/ | | Type of admixtures | | | | |
|---|---|---|---|---|---|---|---|
| | Cement | Admixture | | | | Pozzolith | |
| Sample # | Ratio | content* | ADVA | DARVAN-2 | MELMENT | 400N | TAMOL |
| 42 | 0.45 | 0 | Reference - 58.5 | | | | |
| 43 | | 0.15 | 104.6 | N/A** | N/A | N/A | N/A |
| 44 | | 0.255 | 110 | 55.9 | N/A | N/A | N/A |
| 45 | | 0.3 | 112.4 | N/A | N/A | N/A | N/A |
| 46 | | 0.375 | 150 | N/A | N/A | N/A | N/A |
| 47 | | 0.4 | N/A | N/A | N/A | 115.1 | N/A |
| 48 | | 0.5 | N/A | 78.3 | N/A | N/A | 108.9 |
| 49 | | 0.6 | N/A | N/A | N/A | 117.2 | N/A |
| 50 | | 1 | N/A | 81 | 93.4 | 150 | 126.6 |
| 51 | | 1.25 | N/A | 94.2 | 122 | N/A | 137.8 |
| 52 | | 1.5 | N/A | N/A | 128.5 | N/A | N/A |
| 53 | | 2 | N/A | N/A | 130.4 | N/A | 150 |
| 54 | | 2.5 | N/A | N/A | 150 | N/A | N/A |
| 55 | 0.4 | 0 | Reference - 22.2 | | | | |
| 56 | | 0.15 | 72.4 | N/A | N/A | N/A | N/A |
| 57 | | 0.255 | 74.5 | 14.6 | N/A | N/A | N/A |
| 58 | | 0.3 | 81.9 | N/A | N/A | N/A | N/A |
| 59 | | 0.375 | 100.9 | N/A | N/A | 72.3 | N/A |
| 60 | | 0.45 | 109 | N/A | N/A | N/A | N/A |
| 61 | | 0.5 | | 45.8 | N/A | N/A | 70.4 |
| 62 | | 0.6 | 136.8 | N/A | N/A | 85.5 | N/A |
| 63 | | 1 | 150 | 49.7 | 51.8 | 120 | 83.9 |
| 64 | | 1.25 | | 84.1 | 87.4 | 139.4 | 106.8 |
| 65 | | 1.5 | N/A | N/A | 92.4 | 135.6 | N/A |
| 66 | | 2 | N/A | N/A | 94.4 | N/A | 117.8 |
| 67 | | 2.5 | N/A | N/A | 98.2 | N/A | N/A |
| 68 | | 3 | N/A | N/A | 104 | N/A | N/A |
| 69 | 0.35 | 0.15 | 45.6 | N/A | N/A | N/A | N/A |
| 70 | | 0.255 | 46 | N/A | N/A | N/A | N/A |
| 71 | | 0.3 | 48 | N/A | N/A | N/A | N/A |
| 72 | | 0.375 | 65.4 | N/A | N/A | N/A | N/A |
| 73 | | 0.45 | 73.6 | N/A | N/A | N/A | N/A |
| 74 | | 0.5 | N/A | 7.5 | N/A | N/A | 28.4 |
| 75 | | 0.6 | 95.4 | N/A | N/A | N/A | N/A |
| 76 | | 0.75 | N/A | 13.1 | N/A | N/A | N/A |
| 77 | | 0.9 | 132.8 | N/A | N/A | N/A | N/A |
| 78 | | 1 | N/A | 17.6 | N/A | N/A | 44 |
| 79 | | 1.2 | 109.1 | 57.3 | N/A | N/A | 70.3 |
| 80 | | 1.5 | N/A | N/A | 40.9 | N/A | 96.7 |
| 81 | | 2 | N/A | N/A | 54.1 | N/A | N/A |
| 82 | | 3 | N/A | N/A | 63.5 | N/A | N/A |

*Solid content of waterbase admixture as percent weight of Metamax, sand and cement.
**N/A = not available.

As can be seen from Table 2, the imidized polycarboxylic acid containing hydraulic cement compositions exhibited better flowability at lower dosage for all water/cement ratios. For a composition with a water cement ratio of 0.45, a flowability value of 150% was obtained with only 0.375% of the imidized polycarboxylic polymer. In contrast, to obtain a comparable flow value much higher amounts, i.e., more than 1.25% Darvan-2, 2.5% Melment, 1% of Pozzolith 400N or 2% Tamol were required.

### EXAMPLE 3

Cement composition were prepared with 0.2 parts by weight Metamax, 0.8 parts by weight Portland cement type I, 1.724 parts by weight recycled glass aggregate and water cement weight ratios of 0.25, 0.30, 035, and 0.40. The flowability and 28 day compressive strength in psi of these compositions admixed with either ADVA™ Flow, Melment or Pozzolith 400N was determined using ASTM C109/109M test procedures. The test results are shown in Table 3.

TABLE 3
FLOWABLLITY AND STRENGTH OF
COMPOSITION OF CEMENT WITH METAMAX AND
GLASS AGGREGATE (ASTM C109/C109M)
(First value: flow in %; second value: 28-day
compressive strength in psi)

| Sam- | Water/ | | Type of Admixtures | | |
|---|---|---|---|---|---|
| ple | Cement | Admixture | | | POZZOLITH |
| # | Ratio | Content* | ADVA | MELMENT | 400N |
| 83 | 0.55 | 0 | Reference - 122/6350 | | |
| 84 | 0.4 | 0.132 | 96/12673 | N/A** | N/A |
| 85 | | 0.22 | N/A | 66/10713 | N/A |
| 86 | | 0.468 | N/A | N/A | 89/11907 |
| 87 | | 0.55 | N/A | 85.6/11819 | N/A |
| 88 | | 0.8 | N/A | N/A | 132/13905 |
| 89 | 0.35 | 0.3 | 136.7/14395 | N/A | N/A |
| 90 | | 0.4 | 150/14753 | N/A | N/A |
| 91 | | 1 | N/A | 59/11710 | N/A |
| 92 | | 1.2 | N/A | N/A | 150/13945 |
| 93 | | 3 | N/A | 137/14108 | N/A |
| 94 | 0.3 | 0.375 | 127/17184 | N/A | N/A |
| 95 | | 0.6 | 143/15703 | N/A | N/A |
| 96 | | 1.6 | N/A | N/A | 144/15094 |
| 97 | 0.25 | 0.75 | 141/16338 | N/A | N/A |
| 98 | | 0.9 | 146/15495 | N/A | N/A |

*Solid content of waterbase admixture, weight percent of cement, Metamax and glass aggregate.
**N/A = not available

As can be seen from Table 3, the imidized polycarboxylic acid containing hydraulic cement compositions exhibited better flowability at lower dosage for all water/cement ratios. For a composition with a water cement ratio of 0.4, a flowability of 96% was obtained with only 0.132% of the imidized polycarboxylic polymer. In contrast, to obtain a comparable flow value, much higher amounts, i.e., more than 0.55% of Melment or 0.468% of Pozzolith 400N were required. For a composition with a water cement ratio of 0.35%, a flowability of 150% was obtained with 0.4% of the imidized polycarboxylic polymer, while a similar flow value could be achieved only with using 3% of Melment or 1.2% of Pozzolith400N.

Further as can be seen from Table 3, the addition of 0.375% ADVA™ Flow increases the strength of the composition with a water/cement ratio of 0.3 by a factor of 2.7 compared with a reference mix. In contrast, 3% Melment was required to obtain an increased strength of 2.2 and 1.6% Pozzolith 400N was required to obtain an increased strength factor of 2.4.

### EXAMPLE 4

A cement composition was prepared having the following composition.

| | |
|---|---|
| Metamax | 0.2 parts by weight |
| Portland cement type I | 0.8 parts by weight |
| Recycled glass aggregate | 3 parts by weight |
| ADVA ™ Flow | 1.25% (solid 30%) of |
| | cement/Metamax mixture |
| Water/cement ratio | 0.45 (ratio of weight of water to |
| | cement/Metamax mixture) |

An important property of Metamax is the suppression of alkali-silica reaction if crushed glass is used as the aggregate material. The imidized polycarboxylic polymer of the present invention is very compatible with Metamax in that it allows the metakaolin to develop its full potential in strengthening the mix and suppressing the alkali-silica reaction, while still giving good workability as measured by the flow value. The potential alkali reactivity of the composition was determined using ASTM C1260. As can be seen from Table 4, the observed expansion was approximately 0.01%.

TABLE 4
TEST OF POTENTIAL ALKALI REACTIVITY OF RECYCLED
GLASS AGGREGATES (ASTM C1260-94)
Measurement of Length Change (ASTM 490-97)

| | | Length | | | |
|---|---|---|---|---|---|
| | | Change (mm) of Sample Number | | | |
| Date, Time of Test | Description | 1 | 2 | 3 | 4 |

| | Date of producing | Day 0 | | | |
|---|---|---|---|---|---|
| | Time of Producing | 9:40 AM | | | |
| Day 0 | 1st Reference bar | 0(−7.258) | | 0(−7.258) | |
| Demold, measure | 1st Measurement | −2.1 | −1.964 | −1.66 | −1.724 |
| and put into water | 2^{nd} Reference bar | 0(−7.258) | | 0(−7.258) | |
| and cure in bath | 2^{nd} Measurement | −2.104 | −1.97 | −1.662 | −1.727 |
| 80° C. at 9:40 AM | Correction of Msrmnt. | −2.102 | −1.967 | −1.661 | −1.7255 |
| Day 1 at 9:40 | Reference bar | 0(−7.254) | | | |
| Take out from | Measurement | −1.972 | −1.846 | −1.54 | −1.594 |
| water and put into | | | | | |
| NaOH | | | | | |
| Day 4 at | Reference bar | 0(−7.246) | | 0(−7.250) | |
| 9:40 AM | Measurement | −1.986 | −1.844 | −1.538 | −1.606 |
| | Length change | −0.014 | 0.002 | 0.002 | −0.012 |
| | % of length change | −0.0056 | 0.0008 | 0.0008 | −0.0048 |
| Day 7 at | Reference bar | 0(−7.24) | | 0(−7.24) | |
| 9:40AM | Measurement | −1.962 | −1.832 | −1.526 | −1.602 |
| | Length change | 0.01 | 0.014 | 0.014 | −0.008 |
| | % of length change | 0.004 | 0.0056 | 0.0056 | −0.0032 |
| Day 11 at | Reference bar | 0(−7.238) | | 0(−7.236) | |
| 9:40 AM | Measurement | −1.952 | −1.818 | −1.518 | −1.584 |
| | Length of change | 0.02 | 0.028 | 0.022 | 0.01 |
| | % of length change | 0.008 | 0.0112 | 0.0088 | 0.004 |
| Day 14 at | Reference bar | 0(−7.238) | | 0(−7.236) | |
| 9:40AM | Measurement | −1.948 | −1.83 | −1.512 | −1.572 |
| | Length change | 0.024 | 0.016 | 0.028 | 0.022 |
| | % of length change | 0.0096 | 0.0064 | 0.0112 | 0.0088 |
| 14 days | Average of length | 0.009 | | | |
| | change | | | | |
| Day 16 at | Reference bar | 0(−7.246) | | | |
| 9:40 AM | Measurement | −1.944 | −1.812 | −1.51 | −1.582 |
| | Length change | 0.028 | 0.034 | 0.03 | 0.012 |
| | % of length change | 0.0112 | 0.0136 | 0.012 | 0.0048 |

| | | |
|---|---|---|
| 16 days | Average of length | 0.0104 |
| | change | |

1. A hydraulic cement composition comprising
cement,
an imidized carboxylic polymer,
an alumino-silicate, and
water wherein the weight ratio of water to cement is no greater than 0.6 to 1.

2. A hydraulic cement composition according to claim 1 wherein the imidized carboxylic polymer has the formula: 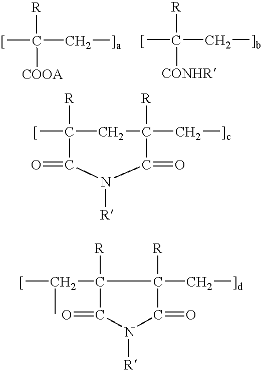
wherein each R independently represents hydrogen atom or a methyl (CH₃—) group; A represents a hydrogen atom, a C₁-C₁₀ alkyl group, or an alkali metal cation or a mixture thereof; R′ represents a hydrogen atom or an oxyalkylene group (BO)n—R″ where O is an oxygen atom, B is a C₂-C₁₀ alkylene group, n=1 to 200, and R″ is C₁-C₁₀ alkyl, or mixtures thereof; and a, b, c, and d represent molar percentages of the polymer's structure such that a has a value of about 50 to 70; the sum of c plus d is at least 2 to a value of (100-a); and b is not more than [100-(a+c+d)].

3. A hydraulic cement composition according to claim 2 wherein B is C₂-C₄ alkylene and n=1-70.

4. A hydraulic cement composition according to claim 1 further comprising an aggregate material.

5. A hydraulic cement composition according to claim 1 wherein the alumino-silicate is a thermally activated alumino-silicate.

6. A hydraulic cement composition according to claim 4 wherein the aggregate comprises glass particles.

7. A hydraulic cement composition according to claim 1 wherein the alumino-silicate is a metakaolin.

8. A method of making a concrete article comprising providing a hydraulic cement composition comprising an imidized carboxylic polymer, an alumino-silicate, cement and water wherein the ratio of water to cement is no greater than 0.6 to 1.
